(19) United States
(12) Patent Application Publication
(10) Pub. No.: US 2009/0173138 A1
(43) Pub. Date: Jul. 9, 2009

(54) SYSTEM AND METHOD FOR CHECKING ELECTRICAL CONTACT POINTS OF SEMICONDUCTOR DEVICES

(75) Inventors: Holger Hoppe, Mering (DE); Erich Mueller, Lappersdorf (DE); Frank Weber, Kraiburg/Inn (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: QIMONDA AG, Muenchen (DE)

(21) Appl. No.: 12/171,947

(22) Filed: Jul. 11, 2008

(30) Foreign Application Priority Data
Jul. 12, 2007 (DE) 102007032560.8-33

(51) Int. Cl. G01N 3/30; G01N 29/00; B07C 5/00

(52) U.S. Cl. 73/12.01; 73/596; 209/600; 901/46

(57) ABSTRACT

A system and method for checking electrical contact points of semiconductor devices. One embodiment includes a check system and a method in which, for the checking of electrical contact points of semiconductor devices, a system is provided by which a number of contact points are impacted with a mechanical load.

### CROSS-REFERENCE TO RELATED APPLICATIONS

his Utility Patent Application claims priority to German Patent Application No. DE 10 2007 032 560.8-33 filed on Jul. 12, 2007, which is incorporated herein by reference.

### BACKGROUND

The present invention relates to a system and to a method for checking electrical contact points of semiconductor devices.

In the context, the term semiconductor devices means in general integrated computing circuits such as, for instance, analog or digital computing circuits, as well as semiconductor memory devices such as, for instance, functional memory devices (PLAs, PALs, etc.), and table memory devices (ROMs or RAMs, in one embodiment SRAMs and DRAMs).

For the common manufacturing of a plurality of semiconductor devices, a wafer, i.e. a thin disc of monocrystalline silicon, is used as a rule. For the structuring of the later circuits, the wafer is subject to a number of processes, e.g., coating, exposure, etching, diffusion, and implantation processes. After the processes having been finished, the semiconductor devices are individualized in that the wafer is sawn apart or scratched and broken.

After the individualization, the electrical connections of the device are soldered to (bonded with) external contact points via thin wires (bond wires). Subsequently, the devices may be molded in a plastics mass, wherein the semiconductor devices obtain specific housings or packages depending on the position of their electrical contact points. The semiconductor devices may, for instance, be molded in a TSOP package of plastics from which the electrical contact points project laterally. Via these connection pins, the semiconductor device may be contacted electrically with the periphery in that the connection pins are directly soldered with electrical lines or are inserted in sockets with appropriate plug connections.

Ball Grid Array (BGA) semiconductor devices are also known in which the electrical connections for contacting the semiconductor device are designed in the form of contact balls (ball pins) on the top or bottom side of the semiconductor device package. The ball pins are usually arranged in fields or matrixes (grid array) that are adapted to be contacted by applying and soldering with complementarily or inversely arranged contact fields. The ball pins on the top or bottom side of the package of the BGA semiconductor device also render it possible to arrange a plurality of semiconductor devices in a stack (stacked module) e.g., in the manner of flip chips on top of each other, and to contact them mutually via the ball pins. This way, it is possible to compose a plurality of semiconductor devices to form a semiconductor assembly or a semiconductor module.

The semiconductor devices with a TSOP package consequently have contact or connection pins at their sides, and semiconductor devices with a BGA package include contact balls at their bottom side or at their top side. The contact points may be fastened insufficiently, which may result in contacting problems or even in the complete disengaging of one or a plurality of contact points or contact balls during later use or further processing.

So far, no method has been known in which specifically weakly fastened contact balls are subject to any bearing test. There is only known a method for optical inspection in which BGA devices are sorted out which are already lacking contact balls or in which contact balls are deformed or damaged, which have been lost or damaged, for instance, in previous test methods or treatment processes. One problem consists in that, in the previous test method, no measures whatsoever are provided for checking a sufficient mechanical stability of the contact balls, so that there is the risk that weakly fastened contact points or contact balls may disengage from the semiconductor device and may thus cause malfunctions. Such malfunctions may occur already during the manufacturing or test method, or only later during use at the customer.

For these and other reasons, there is a need for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates a schematic representation in accordance with one embodiment of a system.

FIG. 2 illustrates a schematic representation in accordance with one embodiment of a system.

FIG. 3 illustrates a schematic representation in accordance with one embodiment of a system.

FIG. 4 illustrates a schematic representation in accordance with one embodiment of a system.

FIG. 5 illustrates a schematic representation in accordance with one embodiment of a system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

One or more embodiments are directed to the ascertaining, detecting, and eliminating of weakly fastened solder contacts or contact balls prior to the dispatch of semiconductor devices or modules. As far as possible, the ascertaining of insufficiently fastened solder contacts or contact balls should be performed prior to the dispatch of the semiconductor devices from the manufacturer to the customer.

One embodiment provides a system for checking electrical contact points of semiconductor devices by which a number of the contact points are impacted with a mechanical load. One embodiment further provides a method for checking electrical contact points or contact balls of semiconductor devices in which a number of the contact points are impacted with a mechanical load so as to check the mechanical strength of the contact points of the devices. The checking of the mechanical strength of the contact points of the devices is, for instance, performed by the disengaging or removing of insufficiently fastened contact points or contact balls.

One embodiment provides a system and a method in which weakly or insufficiently fastened contact points or contact balls of semiconductor devices are removed in time and are made visible, so that defective semiconductor devices may be detected and sorted out before they are further processed or are delivered to the customer. This way, it is possible to only deliver such semiconductor modules or semiconductor devices to the customer which have been checked for a reliable mechanical stability of the contact points or contact balls before, and which are free from mechanical malfunctions. Defective semiconductor devices or modules may, on the contrary, be sorted out, so that they are not used further or are not delivered to the customer, respectively.

With the system and the method according one or more embodiments it is possible to subject the semiconductor devices, for instance, in the course of the manufacturing process in the semi-finished and/or finished state even prior to the incorporation in corresponding semiconductor modules to a check of the electrical contact points. A check of the contact points with respect to the mechanical strength may be performed, i.e. whether the contact point has the desired mechanical strength. After the impacting of the contact points with a mechanical load, further test methods may also be performed by using appropriate test systems or analyzers, for instance, so as to check the electrical contact points also with respect to their electrical functionality, i.e. whether the contact points each provide the desired electrical connection to the semiconductor device.

The detecting of defective contact points or contact balls of the semiconductor devices or modules by the mechanical load or the mechanical stress, respectively, with which they were impacted before may, for instance, be performed by a subsequent optical or sensory inspection, so that the contact balls removed or loosened by the mechanical stress may be ascertained. If it turns out during the inspection that a contact ball or a plurality of contact balls of a semiconductor device has/have disengaged or loosened, the corresponding semiconductor device or module may be marked, sorted out, or eliminated.

The check for disengaged or loosened contact balls at the semiconductor devices or modules may also be performed by an appropriate test device. This may, however, with an increased error ratio due to missing contact balls at the semiconductor devices, result in a time delay in the test methods or in a reduction of the performance in the test methods.

The sorting out of defective semiconductor devices or semiconductor modules may, for instance, be performed at the end of a manufacturing line. The check of the semiconductor devices or the sorting out of the defective semiconductor devices may, for instance, be performed by a mark-scan-pack machine or by a pick-and-place handler for the assembling of semiconductor modules.

Further embodiments of the described device and method for the ascertainment and checking of defective semiconductor devices are illustrated in the enclosed drawings. In the following, the method will be explained in more detail by one or more embodiments.

In the method according to one or more embodiments for the checking of electrical contact points or contact balls of semiconductor devices, a number of the contact points/contact balls are impacted with a mechanical load so as to check the mechanical strength of the contact points or contact balls.

In one embodiment, the contact points/contact balls of the semiconductor device may, for instance, be impacted with a mechanical load by using bristles of one or a plurality of brushes. The bristles of the brush(es) may be moved relative to the contact points of the semiconductor device, and/or the semiconductor device may be moved relative to the bristles. The relative movement between the bristles of the brush(es) and the contact points may, for instance, be produced by a reciprocating movement or a rotary movement of the brush and/or the semiconductor device.

The contact points/contact balls of the semiconductor device may also be impacted with a mechanical load by using an adhesive medium that is applied on a face or on a foil which may be brought into contact with the contact points and then be removed from the contact points again. In one embodiment, the adhesive medium may also be applied on an arcuate face or on a drum which is adapted to be brought into contact with the contact points by a rolling or a rotary movement, and which may then be removed from the contact points/contact balls again. By the rolling or rotary movement, it is possible to additionally produce a relative movement to the contact points of the semiconductor device. In so doing, the loose or unfastened contact balls may get stuck to the adhesive medium at the face or the foil and are removed from the semiconductor device in this way.

The contact points/contact balls of the semiconductor device may also be impacted with a mechanical load by using a fluid flow. A gas flow or liquid flow generated under pressure may, for instance, be directed on the contact points. In accordance with a further embodiment, a number of semiconductor devices may be arranged in a pressure reservoir in which a negative pressure or a positive pressure is generated, so that a fluid flow is generated in the region of the contact points which exerts a mechanical load on the contact points of the semiconductor device.

In accordance with a further embodiment of a method, a number of semiconductor devices may be arranged in a container which includes passages through which a fluid is introduced into the pressure reservoir under pressure, and a fluid is discharged from the pressure reservoir through further passages. Thus, a fluid flow is generated in the region of the contact points/contact balls, so that they are subject to a mechanical load.

In accordance with a further embodiment of a method, the contact points/contact balls of the semiconductor device are impacted with a mechanical load by using ultrasonic waves. In one embodiment, a number of semiconductor devices may be arranged in an ultrasonic reservoir which includes passages through which ultrasonic waves are introduced into the ultrasonic reservoir.

In accordance with a further embodiment of a method, the mechanical loading of the contact points/contact balls of the semiconductor device is effected by using a gauge that is adapted to be brought into contact with the contact points. When the gauge is in contact with the contact points, a relative movement between the gauge and the contact points/contact balls is produced, so that they are subject to a mechanical load. In further embodiments, combinations of the means mentioned may also be used, by which a number of contact points/contact balls of the semiconductor device are impacted with a mechanical load.

After the mechanical loading of the contact points or contact balls of the semiconductor device, an optical check of the contact points/contact balls may be performed so as to detect defective contact points. A check of the contact points may also be performed by using sensory or mechanical scanning means. By the optical or sensory or mechanical check it is possible to detect defective or missing contact points. Furthermore, it is possible to check the contact points of the semiconductor device after the mechanical loading with respect to their electrical functionality.

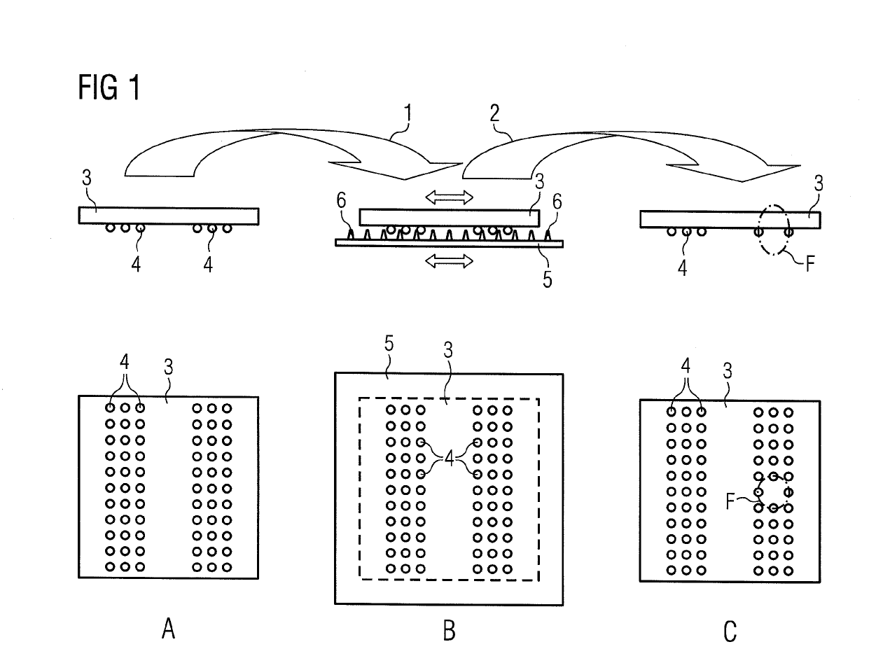

FIGS. 1 to 5 are each constructed such that, in the upper region of the Figures, a corresponding embodiment of a system is illustrated in cross-section in three different states A, B, and C. In the bottom region of FIGS. 1 to 5, a top view of a corresponding embodiment of a system is illustrated in the three different states A, B, and C. These different states A, B, and C also correspond to different phases of a method in the respective embodiment.

FIGS. 1 to 5 illustrate one or more embodiments. The left part of FIGS. 1 to 5 each illustrates a first state of the system or a first phase of a method according to, respectively, the middle part of the Figures each illustrates a second state of the system or a second phase of the method, respectively, and the right part of the Figures each illustrates a third state of the system or a third phase of the method, respectively. In FIGS. 1 to 5, the transition from the first state or from the first phase, respectively, to the second state or to the second phase, respectively, is indicated by the Arrow 1, and the transition from the second state or from the second phase, respectively, to the third state or to the third phase, respectively, is indicated by the Arrow 2.

In the embodiments illustrated in FIGS. 1 to 5, a semiconductor device 3 is illustrated which has contact points 4 arranged at the bottom side thereof. This is a BGA semiconductor device, the electrical connections of which are designed in the form of contact balls (ball pins or solder balls) 4 for contacting the semiconductor device. As is revealed in the top views in the bottom portion of the Figures, the contact balls 4 are arranged in a contact ball matrix (ball grid array).

While FIGS. 1 to 5 illustrate the application of a system and of the method to such a BGA semiconductor device, the present embodiments may also be applied to other kinds of semiconductor devices having contact points of some other design. For the sake of clearness, however, the following figure description refers in one embodiment to BGA semiconductor devices and to contact points that are designed as contact balls.

FIG. 1 illustrates one embodiment of a system for the checking of the electrical contact points or contact balls 4 of semiconductor devices 3, wherein bristles 6 are provided which impact the contact balls 4 with a mechanical load. In one embodiment, the bristles 6 are arranged on a brush 5 such that a mechanical loading of the contact balls 4 is produced by contact and/or friction in a relative movement of the contact balls 4 vis-à-via the bristles 6.

In one embodiment, the semiconductor devices 3 may, for instance, by an equip-remove-robot (not illustrated), be brought into contact with the moving brush 5 or be positioned at a moving brush, and then be removed again. By the mechanical effect of the bristles 6 of the moving brush 5 on the contact balls 4, weakly fastened contact balls are completely detached and removed from the semiconductor device 3. The nature and the movement of the brush 5 and its bristles 6 may be selected such that merely loose and insufficiently fastened contact balls are removed from the semiconductor device 1 while sufficiently fastened contact balls 4 remain fastened to the semiconductor device 1.

As an alternative to a method of contacting the semiconductor devices with a moving brush, the semiconductor device to be checked may also be moved vis-à-vis a stationary brush. It is only the relative movement of the contact points or contact balls of the semiconductor device or module vis-à-vis the brush that is important. In one embodiment illustrated in FIG. 1, the semiconductor device 3 and/or the brush 5 perform a reciprocating movement or a rotary movement, so that a relative movement of the contact balls 4 vis-à-vis the bristles 6 of the brush is produced. The reciprocating movement or rotary movement of the semiconductor device 3 and/or the brush 5 is indicated by the double arrows in the middle portion of FIG. 1.

This way, the contact points 4 of the semiconductor device 3 are checked with respect to their mechanical stability in that the contact balls 4 of the semiconductor device 3 are impacted with a mechanical load or stress. The friction caused by that and the force acting on the contact balls 4 may be adapted to the desired specifications of the contact points 4 or of the semiconductor device 3, respectively. For this purpose, the hardness, the speed of movement, and the size of the brush 5 as well as the length, the stiffness, and the density of the bristles 6 of the brush may be selected correspondingly. The density of the bristles 6 of the brush may, for instance, be selected as a function of the distances of the contact balls 4 within the contact ball field.

In the left portion of FIG. 1, only the semiconductor device 3 is illustrated at the bottom side of which all the contact balls 4 are still available and are arranged in a matrix. In the middle portion of FIG. 1, the contact balls 4 of the semiconductor device 3 are subject to a mechanical load by the contact and the relative movement vis-à-vis the bristles 6 of the brush 5. In so doing, loose and insufficiently fastened contact balls 4′ may be disengaged from the semiconductor device 3 and fall down. Thus, voids are generated in the matrix of the contact balls 4 which are marked with reference number F in the right portion of FIG. 1.

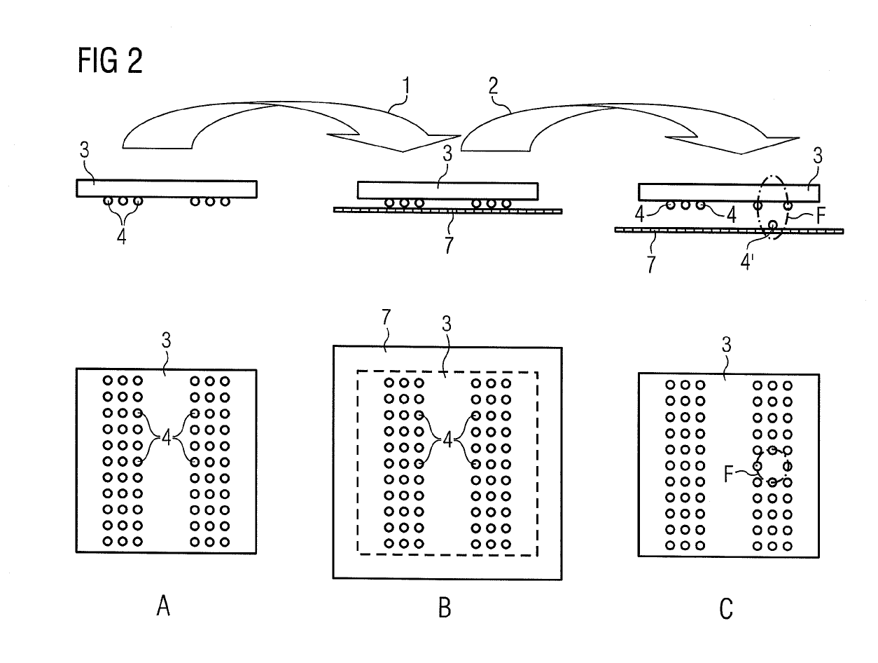

FIG. 2 illustrates one embodiment of a system for the checking of electrical contact points or contact balls of semiconductor devices in which an adhesive medium is used to impact the contact balls 4 of the semiconductor device with a mechanical load. The adhesive medium is used such that a mechanical loading of the contact balls 4 is performed by contact and/or sticking to the adhesive medium.

The adhesive medium may, for instance, be applied on a face or a foil 7 which may be brought into contact with the contact balls 4 and may be removed from the contact balls again. The sticking of the contact balls 4 to the adhesive medium on the face or foil 7 which occurs by that, and the resulting tension force that acts on the contact balls 4 once the face or foil 7 is removed from the contact balls again may, for instance, be adjusted by a suitable selection of the adhesive medium and/or the duration and the contact pressure during the contact of the adhesive medium with the contact balls 4, to the desired specifications of the contact points 4 or of the semiconductor device 3, respectively.

In the left portion of FIG. 2, only the semiconductor device 3 is illustrated at the bottom side of which all the contact balls 4 are still available and are arranged in a matrix. In the middle portion of FIG. 2, the contact balls 4 of the semiconductor device 3 are subject to a mechanical load by the sticking of the contact balls 4 to the adhesive medium and possibly by a relative movement of the contact balls 4 vis-à-vis the foil or face 7. In so doing, loose and insufficiently fastened contact balls 4′ may be completely disengaged from the semiconductor device 3 or get stuck to the adhesive medium. Thus, voids are generated in the matrix of the contact balls 4 which are marked with reference number F in the right portion of FIG. 2. In a subsequent optical or sensory inspection of the contact balls 4 of the semiconductor device 3, such voids F may be detected, and defective semiconductor devices 3 may be sorted out if applicable.

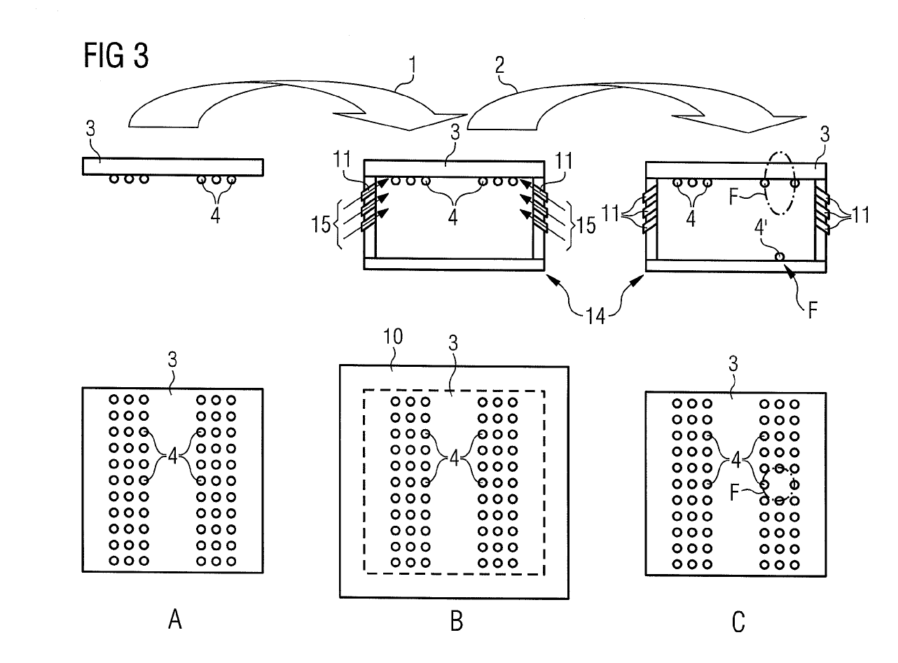

FIG. 3 illustrates one embodiment of a system in which ultrasonic waves are used to impact the contact points of the semiconductor device with a mechanical load. In one embodiment, the system may include means for generating ultrasonic waves which are directed on the contact balls 4, so that the contact balls 4 are subject to a mechanical load.

In one embodiment, the system may include an ultrasonic reservoir 14 for accommodating a number of semiconductor devices, wherein the ultrasonic reservoir 14 includes passages 11 through which the ultrasonic waves 15 can be introduced into the ultrasonic reservoir 14. The ultrasonic waves 15 reach the contact balls 4 and effect a mechanical loading. The mechanical loading of the contact balls 4 generated by this may be adapted to the desired specifications of the contact points 4 or of the semiconductor device 3, respectively, in that, for instance, the intensity and the duration of the impacting of the contact balls 4 with ultrasonic waves are adapted.

In the left portion of FIG. 3, only the semiconductor device 3 is illustrated at the bottom side of which all the contact balls 4 are still available and are arranged in a matrix. In the middle portion of FIG. 3, the contact balls 4 of the semiconductor device 3 are enclosed by the ultrasonic reservoir 14 and are subject to a mechanical load by ultrasonic waves 15. In so doing, loose and insufficiently fastened contact balls 4′ may be disengaged from the semiconductor device 3 and fall down on the bottom of the ultrasonic reservoir 14. Thus, voids are generated in the matrix of the contact balls 4 which are marked with reference number F in the right portion of FIG. 3. In a subsequent optical or sensory inspection of the contact balls 4 of the semiconductor device 3, such voids F may be detected, and defective semiconductor devices 3 may possibly be sorted out.

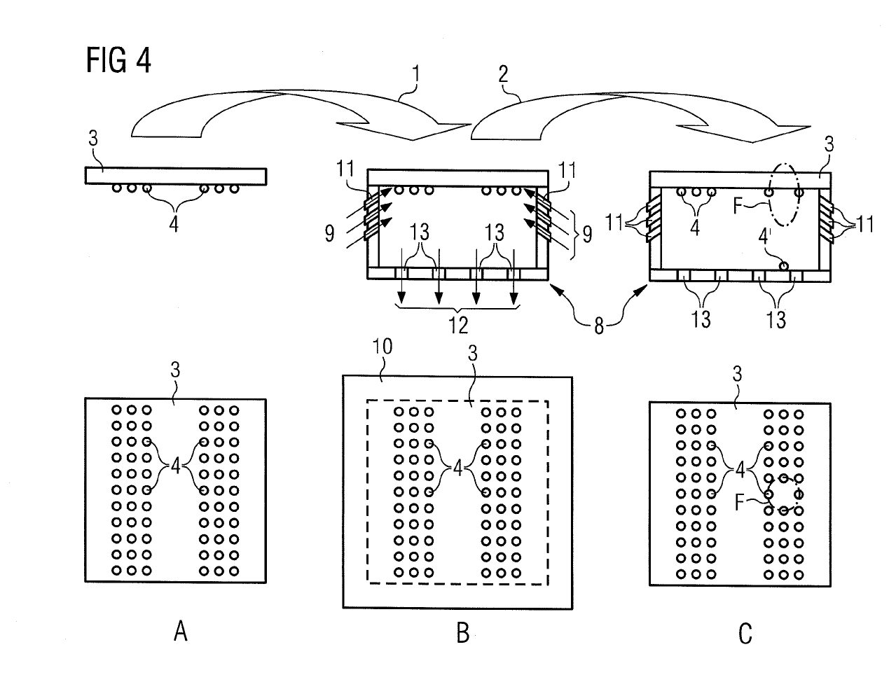

FIG. 4 illustrates one embodiment of a system in which fluid flows 9 are used to subject the contact balls 4 of the semiconductor device 3 to a mechanical load. There may, for instance, be generated a gas flow or a liquid flow 9 under pressure which is directed on the contact balls 4 and thus exerts a force on the contact balls 4.

In one embodiment, the system may include a pressure reservoir 8 which accommodates one or a plurality of semiconductor devices 3 in its interior and surrounds them with its border strip 10. The pressure reservoir 8 includes a number of passages or outlets 13 in the bottom thereof through which fluid flows 12 from the interior of the pressure reservoir 8 may be guided to the outside. Thus, a negative pressure or a vacuum, respectively, may be generated in the interior of the pressure reservoir 8, so that a fluid flow is generated in the region of the contact balls.

The pressure reservoir 8 further includes in its side walls a number of passages or inlets 11 through which fluid flows 9 may be directed under pressure from the outside into the interior of the pressure reservoir 8 on the contact balls 4 of the semiconductor device 3. By the introducing of fluid by using negative pressure in the pressure reservoir 8 and the simultaneous discharging of fluid from the pressure reservoir 8, a fluid flow may be generated in the region of the contact balls 4.

By this incoming flow, the contact balls 4 are subject to a mechanical load that enables a check of the stability thereof. The mechanical loading of the contact balls 4 generated due to the incoming flow of fluid flows 9 may be adapted to the desired specifications of the contact points 4 or of the semiconductor device 3, respectively, in that, for instance, the suitable intensity of the fluid flows 9, the temperature, and/or the density of fluid used are adapted.

In the left portion of FIG. 4, only the semiconductor device 3 is illustrated at the bottom side of which all the contact balls 4 are still available and are arranged in a matrix. In the middle portion of FIG. 4, the contact balls 4 of the semiconductor device 3 are enclosed by the pressure reservoir 8 and are subject to a mechanical load by the incoming flow of fluid flows 9. In so doing, loose and insufficiently fastened contact balls 4′ may be detached from the semiconductor device 3 and fall down on the bottom of the pressure reservoir 8. Thus, voids are generated in the matrix of the contact balls 4 which are marked with reference number F in the right portion of FIG. 4. In a subsequent optical or sensory inspection of the contact balls 4 of the semiconductor device 3, such voids F may be detected, and defective semiconductor devices 3 may possibly be sorted out.

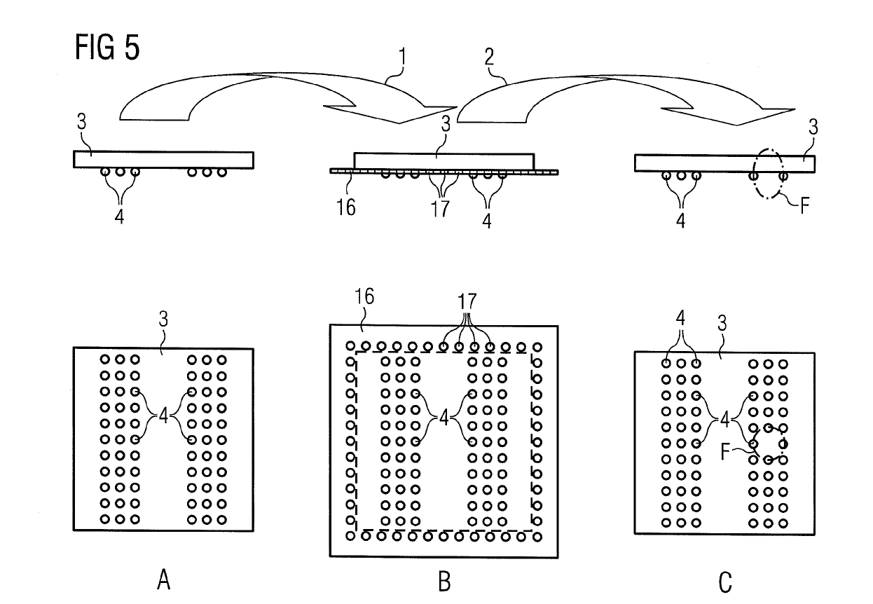

FIG. 5 illustrates one embodiment of a system for the checking of electrical contact points or contact balls of semiconductor devices in which a gauge 16 is provided which is adapted to be brought into contact with the contact balls 4. When the gauge 16 is in contact with the contact points 4, a relative movement between the contact balls 4 and the gauge 16 may be produced, so that the contact balls 4 are impacted with a mechanical load. As a gauge 16, a face or a plate may, for instance, be used, the dimensions of which are adapted to that of the semiconductor device.

The gauge 16 may be movable relative to the contact points 4 of the semiconductor device 3, and/or the semiconductor device 3 may be movable relative to the gauge 16. In addition, the gauge 16 may include depressions and/or holes 17 which are designed complementarily to the contact points 4 and which, on contact of the gauge 16 with the semiconductor device 3, engage the contact balls 4 so as to impact the contact balls 4 specifically with a mechanical load when a relative movement is produced between the contact points 4 and the gauge 16.

The mechanical loading of the contact balls 4 which occurs then may be adapted to the desired specifications of the contact points 4 or of the semiconductor device 3, respectively, in that, for instance, the force and the distance during the production of the relative movement between the contact balls 4 and the gauge 16 are correspondingly adjusted. In further embodiments, combinations of the above-mentioned means for the production of a mechanical loading of the contact balls or contact points 4 of semiconductor devices 3 may also be used.

In the left portion of FIG. 5, only the semiconductor device 3 is illustrated at the bottom side of which all the contact balls 4 are still available and are arranged in a matrix. In the middle portion of FIG. 5, the contact balls 4 of the semiconductor device 3 are subject to a mechanical load by the contact and the relative movement vis-à-vis the gauge 16. In so doing, loose and insufficiently fastened contact balls 4′ may be disengaged from the semiconductor device 3 and fall down. Thus, voids are generated in the matrix of the contact balls 4 which are marked with reference number F in the right portion of FIG. 5. In a subsequent optical or sensory inspection of the contact balls 4 of the semiconductor device 3, such voids F may be detected, and defective semiconductor devices 3 may possibly be sorted out.

For performing the optical or sensory inspection, the system may further be equipped with means for the optical or sensory or mechanical check of the contact points or contact balls 4 of the semiconductor device 3. By using the optical or sensory check it is possible to detect missing contact points or contact balls at the semiconductor device. The means for the sensory check may, for instance, include mechanical scanning means. Other selection means, robots, or automated machines may also be provided which sort out semiconductor devices with defective contact points automatically or semi-automatically.

The system may further include means by which, after the mechanical loading of the contact points 4, a check of the contact balls 4 with respect to their electrical functionality may be performed, i.e. whether the corresponding contact point 4 also provides the desired electrical contact to the semiconductor device 3 in addition to the mechanical strength.

While particular exemplary embodiments have been described in detail in the present description and have been illustrated in the enclosed drawings, such embodiments have to be understood to be illustrative only and not to be restrictive for the scope of protection of the invention. Thus, the present invention may, for instance, also be applied to any kind of semiconductor devices with any kind of contact points, although the application of the system and of the method to a BGA semiconductor device was explained in the enclosed Figures and in the description. It is therefore pointed out that various modifications may be made to the described, illustrated, or other embodiments of the invention without deviating from the scope of protection defined by the enclosed claims and from the gist of the invention.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A check system comprising:
a system configured to check electrical contact points of semiconductor devices including impacting a number of the contact points with a mechanical load.

2. The system of claim 1, comprising wherein bristles are provided and are arranged such that a mechanical loading of the contact points is effected by contact and/or friction with the bristles.

3. The system of claim 2, comprising wherein the bristles are movable relative to the contact points of the semiconductor device, and/or the semiconductor device is movable relative to the bristles.

4. The system of claim 1, comprising wherein adhesive are provided and are arranged such that a mechanical loading of the contact points is effected by contact and/or sticking to the adhesive medium.

5. The system of claim 4, comprising wherein the adhesive is applied on a face or a foil which is adapted to be brought into contact with the contact points and configured to be removed from the contact points again.

6. The system of claim 4, comprising wherein the adhesive is applied on an arcuate face or on a drum configured to be brought into contact with the contact points by a rolling movement or a rotary movement, and configured to be removed from the contact points again.

7. The system of claim 1, comprising a generator of fluid flow is provided, and the mechanical loading of the contact points is effected by using the fluid flow.

8. The system of claim 7, comprising wherein a gas flow or a liquid flow is generated under pressure and is directed on the contact points.

9. The system of claim 1, comprising wherein a negative pressure is provided, and the mechanical loading of the contact points is effected by impacting with negative pressure.

10. The system of claim 1, wherein the system comprises a pressure reservoir for accommodating a number of semiconductor devices, in which a negative pressure or a positive pressure may be generated.

11. The system of claim 10, wherein the pressure reservoir comprises passages through which a fluid may be introduced into the pressure reservoir, and/or a fluid may be discharged from the pressure reservoir.

12. The system of claim 1, comprising wherein ultrasound generator is provided, and the mechanical loading of the contact points is effected by impacting with ultrasonic waves.

13. The system of claim 1, wherein the system comprises an ultrasonic reservoir for accommodating a number of semiconductor devices, wherein the ultrasonic reservoir comprises passages through which ultrasonic waves can be introduced into the ultrasonic reservoir.

14. The system of claim 1, comprising wherein the mechanical loading of the contact points is effected by using at least one gauge that is configured to be brought into contact with the contact points.

15. The system of claim 1, wherein the gauge comprises depressions and/or holes that are formed complementarily to the contact points.

16. The system of claim 15, comprising wherein the gauge is movable relative to the contact points of the semiconductor device, and/or the semiconductor device is movable relative to the gauge.

17. The system of claim 1, comprising wherein an optical check system of the contact points.

18. The system of claim 17, comprising wherein missing contact points at the semiconductor device can be ascertained by using the optical check system.

19. The system of claim 1, comprising wherein an optical and/or sensory scanning system is provided to detect missing contact points at the semiconductor device.

20. The system of claim 1, comprising wherein a selecting system is provided to sort out semiconductor devices with defective contact points.

21. A method for checking electrical contact points of semiconductor devices, comprising:
identifying electrical contact points on a semiconductor device; and
impacting a number of the contact points with a mechanical load.

22. The method of claim 21, comprising checking the strength of the contact points of the semiconductor devices.

23. The method of claim 21, comprising impacting the contact points with a mechanical load by using bristles.

24. The method of claim 23, comprising:
moving the bristles relative to the contact points of the semiconductor device.

25. The method of claim 21, comprising impacting the contact points with a mechanical load by using an adhesive medium applied on a face or on a foil brought into contact with the contact points and then removed from the contact points again.

26. The method of claim 25, comprising:
moving the face or foil with the adhesive medium relative to the contact points of the semiconductor device.

27. The method of claim 21, comprising impacting the contact points with a mechanical load by using a fluid flow.

28. The method of claim 21, comprising directing a gas flow or liquid flow generated under pressure on the contact points for mechanical loading.

29. The method of claim 28, comprising impacting the contact points with a mechanical load by using vacuum or negative pressure.

30. The method of claim 21, comprising arranging a number of semiconductor devices in a pressure reservoir in which a negative pressure or a positive pressure is generated so as to exert a mechanical load on the contact points of the semiconductor device.

31. The method of claim 30, wherein the pressure reservoir comprises passages through which fluid is introduced into the pressure reservoir under pressure, and fluid is discharged from the pressure reservoir through further passages.

32. The method of claim 21, comprising impacting the contact points with a mechanical load by using ultrasonic waves.

33. The method of claim 21, comprising:
arranging a number of semiconductor devices in an ultrasonic reservoir; and
introducing ultrasonic waves into the ultrasonic reservoir through passages in the ultrasonic reservoir.

34. The method of claim 21, comprising performing the mechanical loading of the contact points by using at least one gauge in that the contact points are brought into contact with the gauge and a relative movement between the gauge and the contact points is produced.

35. The method of claim 21, comprising wherein, after the mechanical loading of the contact points, performing an optical check of the contact points.

36. The method of claim 21, comprising wherein, after the mechanical loading of the contact points, performing a check of the contact points by using optical, sensory, or mechanical scanning means.

37. The method of claim 21, comprising detecting defective contact points or missing contact points by using the optical or mechanical check.

38. The method of claim 21, comprising checking the contact points with respect to their electrical functionality after the mechanical loading.

39. The method of claim 21, comprising sorting out semiconductor devices with defective contact points missing contact points.

40. The method of claim 39, comprising performing the sorting out of the defective semiconductor devices by a robot, a mark-scan-pack machine, or by a pick-and-place handler.
